(19) United States
(12) Patent Application Publication
(10) Pub. No.: US 2012/0312798 A1
(43) Pub. Date: Dec. 13, 2012

(54) REFRIGERATOR

(75) Inventor: Hiroshi Aoki, Shiga (JP)

(73) Assignee: PANASONIC CORPORATION, Kadoma-shi, Osaka (JP)

(21) Appl. No.: 13/579,193

(22) PCT Filed: Mar. 10, 2011
(86) PCT No.: PCT/JP2011/001394

§ 371 Date: Aug. 15, 2012

(30) Foreign Application Priority Data
Mar. 15, 2010 (JP) 2010-057088

(51) Int. Cl. H05B 1/00

(52) U.S. Cl. 219/220

(57) ABSTRACT

A refrigerator of the present invention includes a heat-insulating housing having an opening in a front surface, a partition wall (153) for dividing the heat-insulating housing into right and left parts, and a first storage room and a second storage room divided by the partition wall (153). In the refrigerator of the present invention, a temperature range of the first storage room is set higher than that of the second storage room. The partition wall (153) has a lighting unit (200) having a semiconductor light-emitting element (203) as a light source, on at least the first storage room side, and a heater (600) is disposed on the rear surface of the lighting unit (200). With this configuration, since inside of the storage room is bright, the visibility is good. Furthermore, since occurrence of dew condensation is suppressed, the reliability of lighting unit (200) is improved.

### TECHNICAL FIELD

The present invention relates to a refrigerator having storage rooms on the right and left sides.

### BACKGROUND ART

A refrigerator has a lighting unit for illuminating the inside of a storage room. Recently, as a light source of the lighting unit, a semiconductor light-emitting element (for example, a light-emitting diode, hereinafter, referred to as “LED”) is used. The LED has small power consumption and long lifetime.

A lighting unit of a refrigerator is disposed on a wall in a deep side of a storage room, or in the center of a ceiling of a storage room as disclosed in, for example, Patent Literature 1. In this configuration, since light is obstructed by stored items, the inside of the storage room becomes dark. In other words, the visibility in the storage room becomes bad. In such a case, it is difficult to recognize the types of the stored items, or to determine freshness of the stored items.

Furthermore, depending upon where a lighting unit is disposed, dew condensation occurs on the lighting unit. When dew condensation occurs on the lighting unit and water from the dew condensation reaches a circuit board, LED is in poor electrification or the like. That is to say, the reliability of the lighting unit is deteriorated.

### CITATION LIST

### Patent Literatures

PTL 1: Japanese Patent Unexamined Publication No. 2005-344975

### SUMMARY OF THE INVENTION

The present invention provides a refrigerator including a lighting unit with which a storage room is brightly illuminated and in which occurrence of dew condensation is suppressed.

A refrigerator according to the present invention includes a heat-insulating housing having an opening in a front surface, a partition wall that divides the heat-insulating housing into right and left parts, and a first storage room and a second storage room divided by the partition wall. In the refrigerator of the present invention, a temperature range of the first storage room is set higher than that of the second storage room. Furthermore, in the refrigerator of the present invention, the partition wall has a lighting unit having a semiconductor light-emitting element as a light source, on at least the first storage room side, and a heater is disposed on the rear surface of the lighting unit.

With this configuration, the inside of the storage room is bright, so that good visibility can be achieved. Furthermore, since occurrence of dew condensation is suppressed, the reliability of the lighting unit is improved.

### BRIEF DESCRIPTION OF THE DRAWINGS

FIG. 1 is a perspective view of a refrigerator in accordance with a first exemplary embodiment of the present invention.

FIG. 2 is a perspective view of the refrigerator in another state in this exemplary embodiment.

FIG. 3 is a perspective view of the refrigerator in still another state in this exemplary embodiment.

FIG. 4 is a perspective view of a heat-insulating housing of the refrigerator in this exemplary embodiment.

FIG. 5 is a side view of a principal part of the inside of the refrigerator in this exemplary embodiment.

FIG. 6 is a sectional view of a lighting unit of the refrigerator in this exemplary embodiment.

FIG. 7 is another sectional view of lighting units of the refrigerator in this exemplary embodiment.

FIG. 8 is a perspective view of a ceiling of the inside of the refrigerator in this exemplary embodiment.

FIG. 9A is a view for illustrating an operation of the lighting unit of the refrigerator in this exemplary embodiment.

FIG. 9B is a view for illustrating an operation of the lighting unit of the refrigerator in this exemplary embodiment.

FIG. 10 is another perspective view of a heat-insulating housing of a refrigerator in this exemplary embodiment.

FIG. 11 is a perspective view of a heat-insulating housing of a refrigerator in accordance with a second exemplary embodiment of the present invention.

FIG. 12 is a sectional view of the refrigerator in this exemplary embodiment.

FIG. 13 is a perspective view of an inner box of the refrigerator in this exemplary embodiment.

FIG. 14 is a perspective view of a base of the refrigerator in this exemplary embodiment.

FIG. 15 is another perspective view of a base of the refrigerator in this exemplary embodiment.

FIG. 16 is a longitudinal sectional view of FIG. 15.

FIG. 17A is a sectional view showing a first example of arrangement of lighting units in a refrigerator in accordance with a third exemplary embodiment of the present invention.

FIG. 17B is a sectional view showing a second example of arrangement of lighting units in the refrigerator in this exemplary embodiment.

FIG. 17C is a sectional view showing a third example of arrangement of lighting units in the refrigerator in this exemplary embodiment.

FIG. 17D is a sectional view showing a fourth example of arrangement of lighting units in the refrigerator in this exemplary embodiment.

FIG. 17E is a sectional view showing a fifth example of arrangement of lighting units in the refrigerator in this exemplary embodiment.

FIG. 17F is a sectional view showing a sixth example of arrangement of lighting units in the refrigerator in this exemplary embodiment.

FIG. 17G is a sectional view showing a seventh example of arrangement of lighting units in the refrigerator in this exemplary embodiment.

FIG. 17H is a sectional view showing an eighth example of arrangement of lighting units in the refrigerator in this exemplary embodiment.

FIG. 18 is a perspective view of heat-insulating housing of a refrigerator in accordance with a fourth exemplary embodiment of the present invention.

### DETAILED DESCRIPTION OF THE PREFERRED EMBODIMENT

### First Exemplary Embodiment

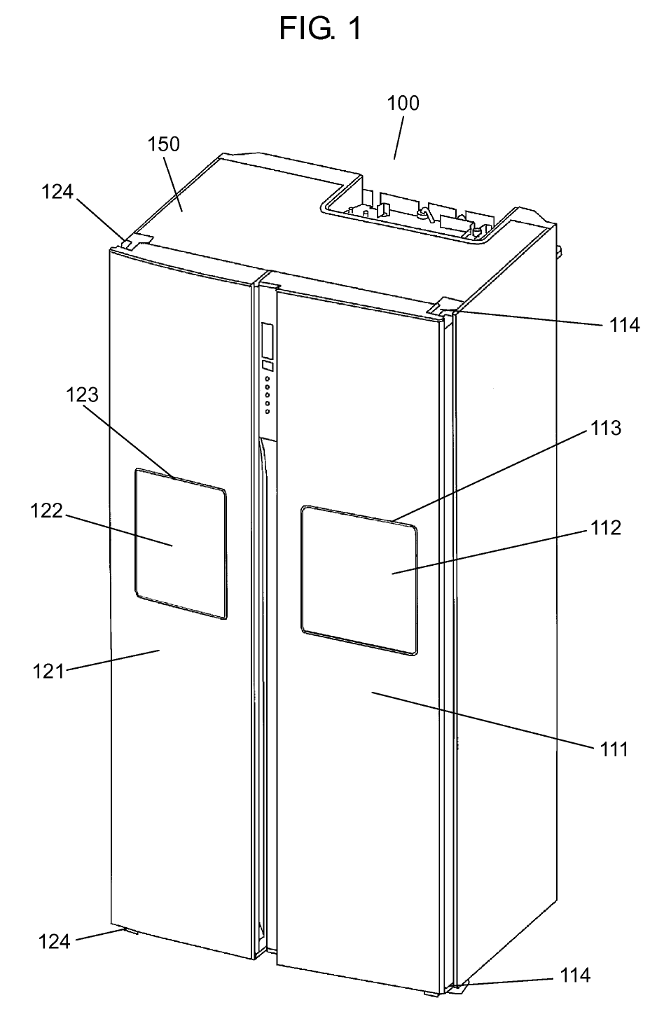

FIG. 1 is a perspective view of a refrigerator in accordance with a first exemplary embodiment of the present invention. Refrigerator 100 includes heat-insulating housing 150, first door 111, and second door 121. First door 111 has third door 112. Second door 121 has fourth door 122.

Heat-insulating housing 150 has openings in a front surface.

Heat-insulating housing 150 is produced by, for example, foaming and filling a heat-insulating material such as urethane between an outer box made of a steel plate and an inner box made of resin. The heat-insulating material blocks heat entering between the inside and the outside of heat-insulating housing 150 (that is to say, refrigerator 100).

First door 111 opens and closes an opening on the right side facing toward heat-insulating housing 150. Heat-insulating housing 150 and first door 111 are coupled to each other with hinges 114 provided on the upper and lower ends of the right side of heat-insulating housing 150. Therefore, first door 111 turns around the right end of heat-insulating housing 150 as an axis.

Second door 121 opens and closes an opening on the left side facing toward heat-insulating housing 150. Heat-insulating housing 150 and second door 121 are coupled to each other with hinges 124 provided on the upper and lower ends of the left side of heat-insulating housing 150. Therefore, second door 121 turns around the left end of heat-insulating housing 150 as an axis. In this exemplary embodiment, second door 121 has a narrower width than that of first door 111.

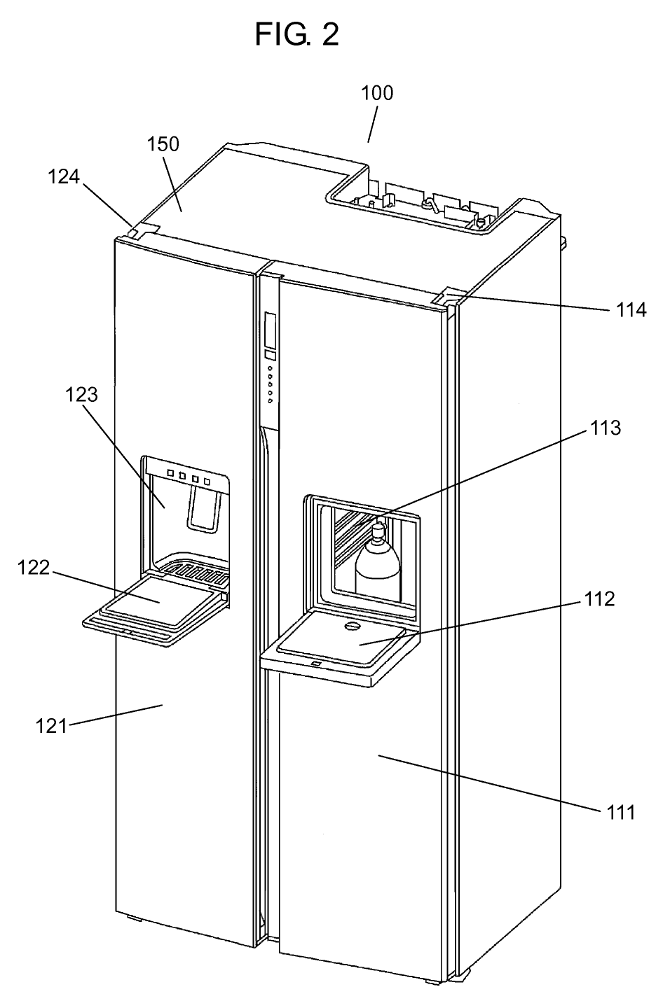

FIG. 2 is a perspective view of the refrigerator in another state in this exemplary embodiment. Specifically, FIG. 2 shows a state in which third door 112 and fourth door 122 are opened.

First door 111 has through hole 113. Through hole 113 penetrates first door 111 in the thickness direction. Through hole 113 is formed so that stored items are put in and taken out without opening first door 111.

Third door 112 opens and closes through hole 113. Third door 112 turns around the lower end of through hole 113 as an axis using hinges (not shown). Third door 112 has a substantially square shape having round corners.

Second door 121 has dispenser 123. Dispenser 123 is, for example, an ice dispenser for supplying ice, or a water dispenser for supplying water.

Fourth door 122 opens and closes an opening of dispenser 123. Fourth door 122 turns around the lower end of the opening of dispenser 123 using hinges (not shown). Fourth door 122 has a substantially square shape having round corners.

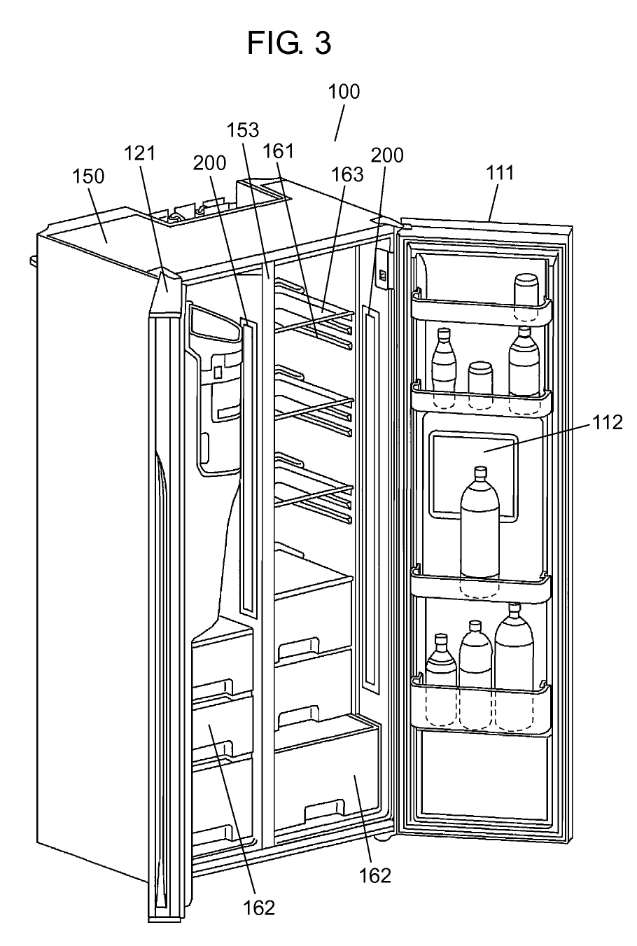

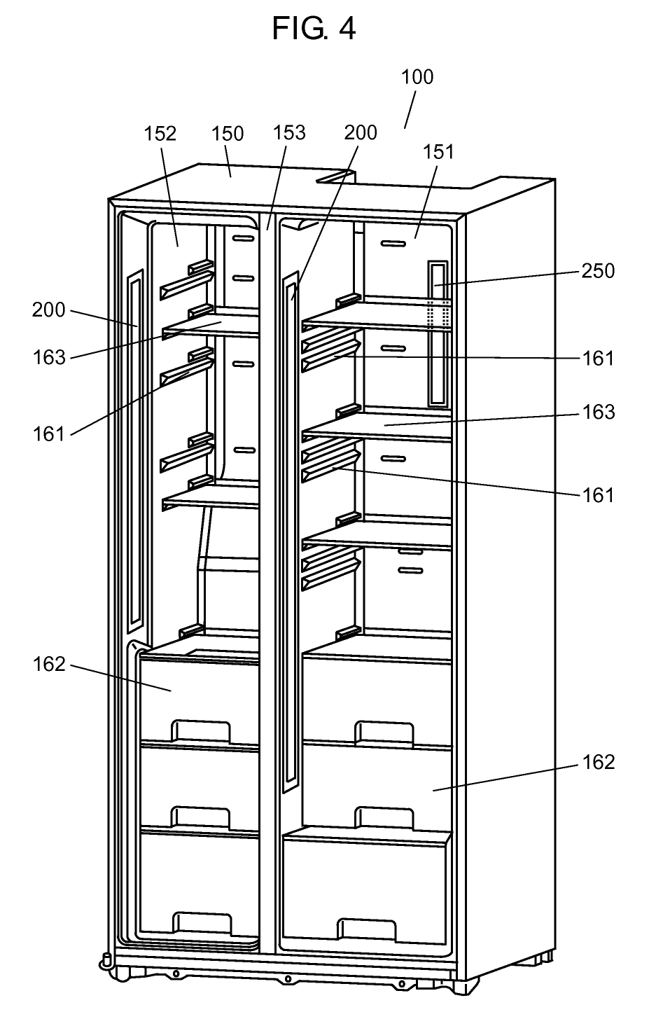

FIG. 3 is a perspective view of the refrigerator in still another state in this exemplary embodiment. Specifically, FIG. 3 shows a state in which first door 111 and second door 121 are opened. FIG. 4 is a perspective view of heat-insulating housing 150 of the refrigerator in this exemplary embodiment. FIG. 4 is a perspective view in which first door 111 and second door 121 of refrigerator 100 are omitted.

Refrigerator 100 includes partition wall 153, lighting units 200, deep-side lighting unit 250, rail members 161, and drawers 162. Shelf plates 163 are mounted on rail members 161.

Partition wall 153 is a wall that divides the inside of heat-insulating housing 150 into right and left parts. Similar to heat-insulating housing 150, partition wall 153 is produced by foaming and filling a heat-insulating material such as urethane into the inside thereof. That is to say, partition wall 153 has a heat-insulating property. The right side of partition wall 153 is first storage room 151. First storage room 151 operates as a refrigeration room. The left side of partition wall 153 is second storage room 152. Second storage room 152 operates as a freezing room. That is to say, a temperature range of first storage room 151 is set higher than that of second storage room 152. Partition wall 153 is a wall for dividing into the refrigeration room and the freezing room having different temperature ranges.

Rail members 161 are provided on the inner side walls of refrigerator 100, that is, the inner side surfaces of heat-insulating housing 150 and the side surfaces of partition wall 153. Each rail member 161 extends horizontally in the back-and-forth direction of heat-insulating housing 150. In this exemplary embodiment, each rail member 161 is configured by attaching a stick-shaped member on the inner side wall of refrigerator 100. Rail member 161 can be also configured by forming the inner side wall of refrigerator 100 in such a manner that it protrudes. Rail member 161 can be also configured by forming a groove on the inner side wall of refrigerator 100.

Shelf plate 163 is disposed in a bridging state between rail member 161 provided on the inner side surface of heat-insulating housing 150 and rail member 161 provided on the side surface of partition wall 153. Shelf plate 163 is detachable with respect to rail member 161. A depth of shelf plate 163 is shorter than a depth of the inside of heat-insulating housing 150. Shelf plate 163 has strength capable of mounting stored items. It is preferable that shelf plate 163 is made of a material through which light passes. For example, shelf plate 163 is made of glass, transparent resin, or the like. Alternatively, shelf plate 163 is made of a material, for example, a wire net or a perforated metal sheet, which have a plurality of holes through which light passes.

Drawer 162 is a container disposed in heat-insulating housing 150. Drawer 162 has a box shape that is opened toward the upper side. Drawer 162 is slidable with respect to heat-insulating housing 150 in the back-and-forth direction.

Three drawers 162 of first storage room 151 are disposed in the vertical direction. Each of upper two drawers 162 in first storage room 151 has a width equal to an inner width of first storage room 151, and has a depth equal to a depth of shelf plate 163. Lowermost drawer 162 of first storage room 151 has a width equal to an inner width of first storage room 151, and has a depth longer than the other two drawers 162. Specifically, lowermost drawer 162 of first storage room 151 has a depth equal to a depth of the inside of heat-insulating housing 150.

Three drawers 162 of second storage room 152 are disposed in the vertical direction. All drawers 162 of second storage room 152 have a width equal to the inner width of second storage room 152, and have a depth equal to the depth of the inside of heat-insulating housing 150.

It is preferable that any of drawers 162 are made of a material through which light passes. For example, at least a front part of drawer 162 is made of glass, a transparent resin, or the like. In this exemplary embodiment, the entire part of drawer 162 is integrally formed of a transparent resin. With this configuration, light passes through the inner part of drawer 162. As a result, light enters the inside of drawer 162, and at the same time, the humidity of the inside is maintained since drawer 162 is an integrally molded with resin.

Lighting unit 200 uses a semiconductor light-emitting element (for example, LED) as a light source. Lighting unit 200 is disposed in the vicinity of the opening of each of first storage room 151 and second storage room 152. That is to say, lighting unit 200 is disposed on the inner side surface of heat-insulating housing 150 and the side surface of partition wall 153 that are the inner side walls of refrigerator 100 and in the vicinity of the opening thereof. Herein, the vicinity means a place that is the front side from the front end part of shelf plate 163, and the rear side from the front end part of heat-insulating housing 150.

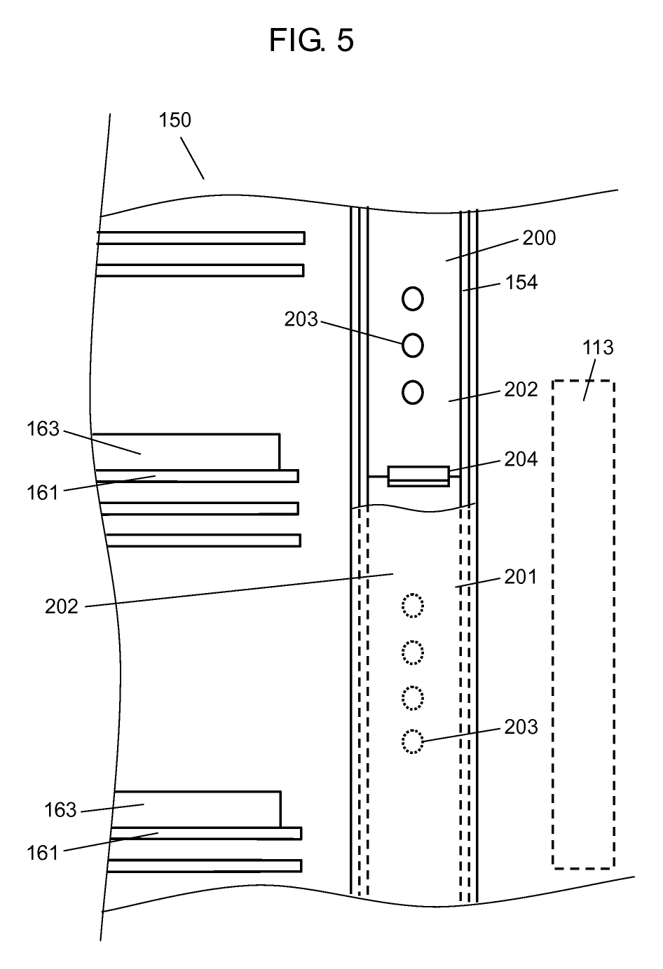

FIG. 5 is a side view of a principal part of the inside of the refrigerator in accordance with this exemplary embodiment. FIG. 5 particularly shows lighting unit 200 in which a part of lighting unit 200 is cut away. In FIG. 5, the right side shows a front surface of refrigerator 100. FIG. 6 is a sectional view of the lighting unit of the refrigerator in this exemplary embodiment. In particular, FIG. 6 is a horizontally taken sectional view of lighting unit 200 disposed on the inner side surface of heat-insulating housing 150. In FIG. 6, the lower side shows the inner side of heat-insulating housing 150, and the right side is a front surface of refrigerator 100. FIG. 7 is another sectional view of lighting units of the refrigerator in this exemplary embodiment. FIG. 7 is a horizontally taken sectional view, which shows lighting unit 200 disposed on the side surface of partition wall 153. In FIG. 7, the right side shows a front surface of refrigerator 100. That is to say, in FIG. 7, the upper side and the lower side show the inner side of heat-insulating housing 150.

Lighting unit 200 includes cover 201, substrate 202, LED 203, and connector 204. Lighting unit 200 is accommodated in concave portion 154 formed in the inner wall surface of refrigerator 100. As shown in FIG. 7, lighting units 200 disposed on the side surface of partition wall 153 are disposed in a state in which the back side of lighting unit 200 for illuminating first storage room 151 and the back side of lighting unit 200 for illuminating second storage room 152 face each other. When lighting unit 200 is disposed on partition wall 153 in this way, a part having thin heat-insulating material 153a is generated in partition wall 153. In this part, the heat-insulating performance is deteriorated. However, an object of partition wall 153 is not heat insulation from the outside, but heat insulation between first storage room 151 as a refrigeration room and second storage room 152 as a freezing room. Therefore, partition wall 153 is not required to have higher heat-insulating performance as compared with that of heat-insulating housing 150. Therefore, partition wall 153 is suitable as a place on which lighting unit 200 is disposed.

Lighting unit 200 is configured in a long length in the vertical direction. An upper end of lighting unit 200 is located in a higher part than uppermost rail member 161, and a lower end of lighting unit 200 is located in a lower part than the lowermost rail member 161. The lower end of lighting unit 200 is located in a lower part than the lower surface of uppermost drawer 162, and in a higher part than the lower surface of drawer 162 provided below uppermost drawer 162. The upper end of lighting unit 200 disposed in first storage room 151 is located in a higher part than the upper end of through hole 113, and the lower end of lighting unit 200 is located in a lower part than the lower end of through hole 113.

Cover 201 protects LED 203 and substrate 202 from environment (that is, cold air and water vapor) of first storage room 151 and second storage room 152. When cold air and water vapor of first storage room 151 and second storage room 152 are brought into direct contact with LED 203 or substrate 202, dew condensation may occur in LED 203 or substrate 202. Therefore, cover 201 prevents electrical malfunction due to the dew condensation in LED 203 and substrate 202. Cover 201 allows light radiated from LED 203 to pass. An entire surface or a partial surface of cover 201 is subjected to crimp process. With crimp process, light radiated from LED 203 is irregularly refracted. First storage room 151 and second storage room 152 are illuminated by irregularly refracted light.

Substrate 202 holds a plurality of LEDs 203. Substrate 202 has wiring (for example, printed wiring) for connecting LEDs 203 to a power source or the like. Substrate 202 has a rectangular shape, and LEDs 203 are provided in a line along the longitudinal direction. Substrate 202 has connectors 204 on both ends in the longitudinal direction. Connector 204 includes a male connector at one end side of substrate 202 and a female connector at another end side of substrate 202.

By connecting male-side connector 204 of substrate 202 and female-side connector 204 of other substrate 202, substrates 202 are connected to each other. By connecting a plurality of substrates 202 to each other in the vertical direction in this way, lighting unit 200 is configured. Substrates 202 are disposed such that the connection places are in the same height as that of rail members 161. By connecting substrates 202 appropriately, LEDs 203 are disposed in appropriate positions. Note here that LEDs 203 are disposed such that they are not disposed in the same height as rail member 161 and shelf plate 163 in the vertical direction.

Each of LEDs 203 is a semiconductor element that emits light when an electric current is allowed to flow. As LED 203, for example, a semiconductor element that emits white light is used. LEDs 203 disposed in first storage room 151 and LEDs 203 disposed in second storage room 152 emit light having different white emission light. Specifically, LEDs 203 disposed in first storage room 151 emit orangish white light, and LEDs 203 disposed in second storage room 152 emit bluish white light.

A user feels that bluish white light is slightly darker than orangish white light. Furthermore, a smaller amount of electric current is allowed to flow into LEDs 203 disposed on second storage room 152, as compared with the amount of electric current that flows into LEDs 203 disposed in first storage room 151. Thus, a user feels that second storage room 152 is darker than first storage room 151. Note here that colors or brightness of light released from lighting units 200 can be adjusted by adjusting LEDs 203, adjusting materials of cover 201, and adjusting shapes of cover 201.

As shown in FIGS. 6 and 7, substrate 202 is disposed obliquely such that it faces a deep part of heat-insulating housing 150 (that is to say, a deep part of refrigerator 100). Thus, LED 203 faces the deep part of heat-insulating housing 150. Therefore, as shown in light axis 231, the inner part of heat-insulating housing 150 is illuminated more. That is to say, stored items are illuminated brightly. Note here that light axis 231 is a virtual axis showing a representative direction of light from LED 203.

For deep-side lighting unit 250, LED is used as a light source. Deep-side lighting unit 250 is disposed on a wall of the deep side of first storage room 151. Specifically, deep-side lighting unit 250 is disposed in such a manner that it is embedded in the wall at the deep side of heat-insulating housing 150. As shown in FIG. 4, the lower end of deep-side lighting unit 250 is located in a lower part than the upper end of lighting unit 200.

As shown in FIG. 7, heater 600 is provided on concave portion 154 of partition wall 153. That it so say, heater 600 is provided so as to cover the rear surface extending upwardly and downwardly in lighting unit 200. Heater 600 is made of, for example, a flat aluminum heater. Heater 600 is supplied with electric power from heater wire 600a. Heater wire 600a is wired on a portion excluding a reinforcement rib (not shown) on concave portion 154.

In FIG. 7, heater 600 is provided on both concave portion 154 at first storage room 151 side and concave portion 154 at second storage room 152 side of partition wall 153. On the other hand, heater 600 may be provided only on concave portion 154 at first storage room 151 side of partition wall 153. In this case, heater 600 heats lighting unit 200 for illuminating first storage room 151 side that operates as a refrigeration room.

Herein, when heater 600 is not provided, with cold air from second storage room 152 as a freezing room, lighting units 200 at both second storage room 152 side and first storage room 151 side are cooled. Since first storage room 151 is a refrigeration room, it has a higher temperature than that of second storage room 152. With this difference in temperature, dew condensation may occur in lighting units 200 for illuminating first storage room 151.

In this exemplary embodiment, since the rear surface of lighting units 200 is heated by heater 600, occurrence of dew condensation is prevented. As a result, poor electrification of substrate 202 or LED 203 caused by dew condensation water is prevented. That is to say, the reliability of lighting unit 200 is improved.

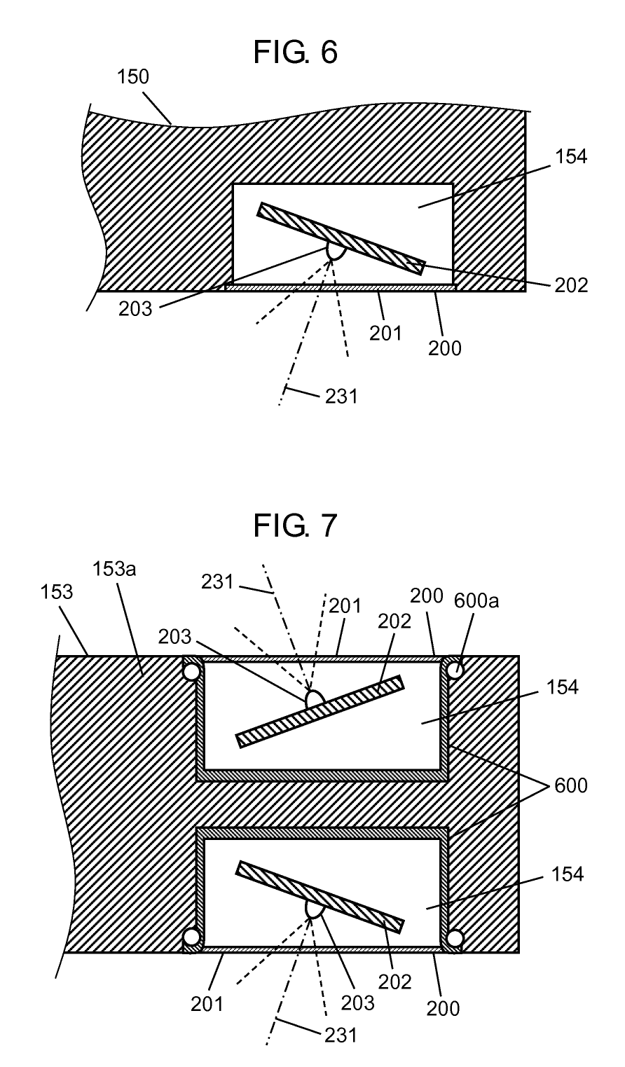

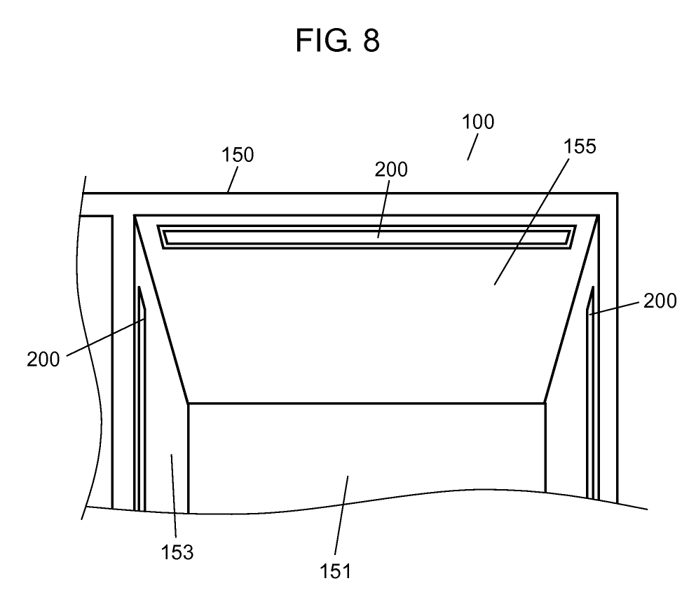

FIG. 8 is a perspective view of a ceiling of the inside of the refrigerator when it is seen from the lower side in this exemplary embodiment. Refrigerator 100 includes lighting unit 200 also on ceiling 155. Lighting unit 200 disposed on ceiling 155 has a length that is not shorter than the width of first storage room 151. Lighting unit 200 disposed on ceiling 155 is long in the right and left direction, and is disposed in the vicinity of the opening of refrigerator 100.

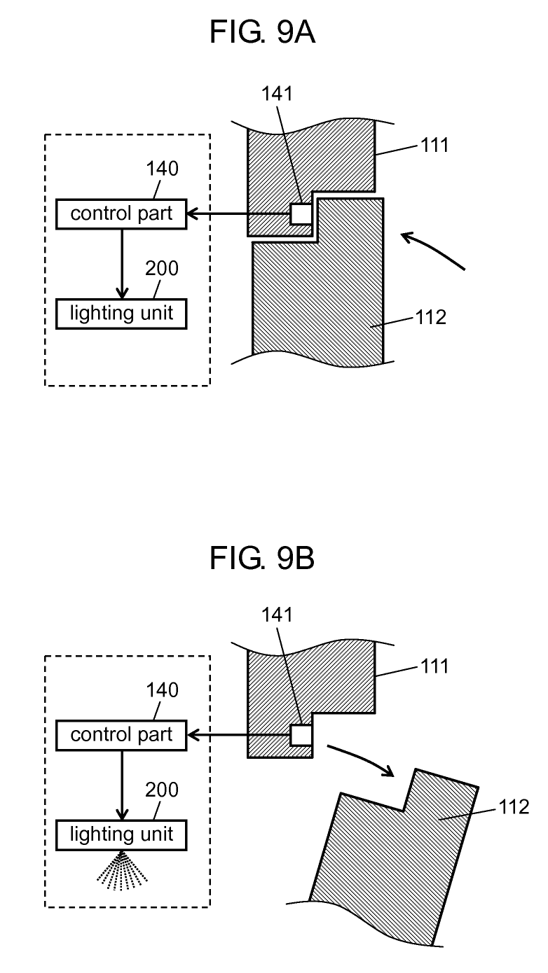

FIGS. 9A and 9B are views each illustrating an operation of the lighting unit of the refrigerator in this exemplary embodiment. Specifically, FIG. 9A is a sectional view of a principal part of first door 111 and third door 112, and an electrical block diagram, showing a state in which third door 112 is closed. Similarly, FIG. 9B is a sectional view of a principal part of first door 111 and third door 112, and an electrical block diagram, showing a state in which third door 112 is opened. With FIG. 9A and FIG. 9B, an electrical operation of lighting unit 200 is described.

Refrigerator 100 includes detection part 141 and control part 140. Detection part 141 is a sensor that detects an opened state and a closed state of third door 112. Detection part 141 is, for example, a micro switch. Detection unit 141 is in the ON state when third door 112 is closed, and detection unit 141 is in the OFF state when third door 112 is opened.

Control unit 140 controls lighting on and lighting off of lighting units 200 according to the state of detection part 141. Control part 140 allows lighting unit 200 to be turned off when detection part 141 is in the ON state, and allows lighting unit 200 to be turned on when detection part 141 is in the OFF state. That is to say, control part 140 allows lighting unit 200 to be turned off when third door 112 is closed. Control part 140 allows lighting unit 200 to be turned on when third door 112 is opened.

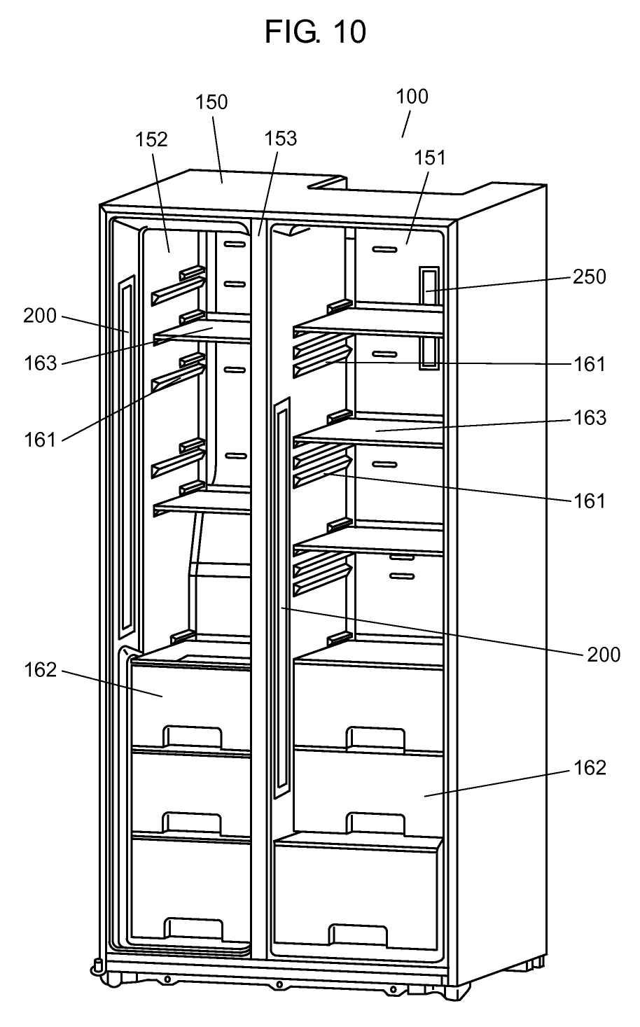

FIG. 10 is another perspective view of a heat-insulating housing of a refrigerator in this exemplary embodiment. Specifically, FIG. 10 shows another example of arrangement of lighting units 200. In first storage room 151, the upper end of lighting unit 200 is located in the lower part than the lower end of deep-side lighting unit 250. That is to say, lighting unit 200 and deep-side lighting unit 250 are not overlapped on each other in the vertical direction. Lighting units 200 may be disposed in this way.

Herein, the inner side surface of heat-insulating housing 150 and the side surface of partition wall 153 are configured basically perpendicular to an opening surface of heat-insulating housing 150. In detail, the inner side surface of heat-insulating housing 150 is configured in such a manner that it is inclined toward the outside of heat-insulating housing 150 in the vicinity of the opening. Furthermore, the side surface of partition wall 153 is configured in such a manner that it is inclined toward the side surface of facing partition wall 153 in the vicinity of the opening of heat-insulating housing 150. That is to say, the thickness of the heat-insulating material of heat-insulating housing 150 and partition wall 153 is reduced toward the front surface in the vicinity of the opening of heat-insulating housing 150. Note here that, such inclination may be formed in at least a part of the surface instead of being formed on the entire surface. Since lighting unit 200 is disposed on the inclined surface, when lighting units 200 are not provided on the inclined surface, the thickness of the heat-insulating material is not reduced. That is to say, the heat-insulating performance is maintained.

### Second Exemplary Embodiment

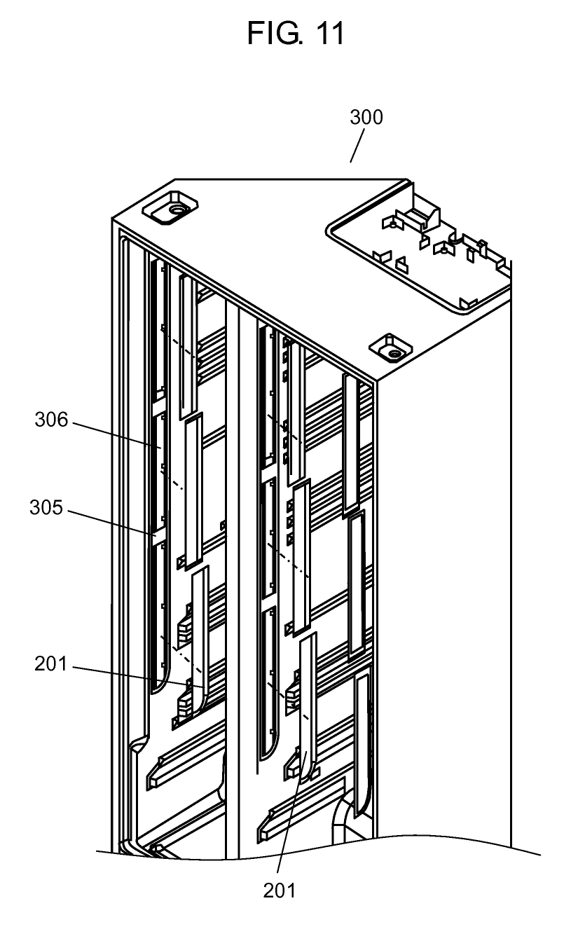

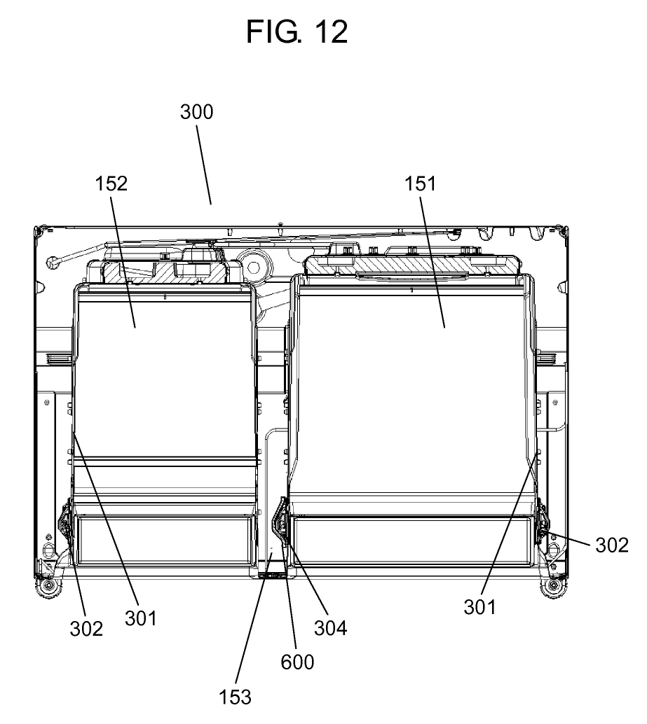

FIG. 11 is a perspective view of a heat-insulating housing of a refrigerator in accordance with a second exemplary embodiment of the present invention. FIG. 12 is a sectional view of the refrigerator in this exemplary embodiment. FIG. 12 is a horizontally taken sectional view of the refrigerator in which each door is not shown. In this exemplary embodiment, the same reference numerals are given to the same configuration as in the first exemplary embodiment. This exemplary embodiment is different from the first exemplary embodiment in that no lighting units are disposed on a partition wall side of a second storage room.

Similar to the first exemplary embodiment, first storage room 151 that operates as a refrigeration room and second storage room 152 that operates as a freezing room are provided in left and right positions of refrigerator 100. Lighting unit 302 is disposed in the vicinity of an opening of side wall part 301 that is an inner side surface of heat-insulating housing 300. Lighting units 302 are disposed in first storage room 151 and second storage room 152, respectively. Lighting unit 304 is disposed in the vicinity of the opening of partition wall surface 303 at first storage room side, which is a side surface of first storage room 151 side of partition wall 153.

As shown in FIG. 12, lighting units 302 and lighting unit 304 are embedded in a heat-insulating material of each wall surface. Lighting unit 304 is provided with heater 600. That is to say, heater 600 is provided between a rear surface of lighting unit 304 and the heat-insulating material filled in partition wall 153.

First storage room 151 has a larger width than that of second storage room 152. First storage room 151 is illuminated from the right and left sides by lighting unit 302 and lighting unit 304. Therefore, the inside of first storage room 151 is bright. On the other hand, second storage room 152 is illuminated by only lighting unit 302, that is to say, illuminated from only one side. Since second storage room 152 has a smaller width than that of first storage room 151, it has sufficient brightness. In this configuration, partition wall 153 has lighting unit 304 only on first storage room 151 side. Therefore, since the thickness of the heat-insulating material of partition wall 153 can be increased, the heat-insulating performance of partition wall 153 is improved.

Lighting unit 302 and lighting unit 304 of first storage room 151 and lighting unit 302 of second storage room 152 are aligned in height of the upper end and the lower end. That is to say, the position of the upper and the position of the lower end coincide with each other in the vertical direction. Lighting unit 302 and lighting unit 304 have a plurality of LEDs 203 as a light source, respectively. The positions of corresponding LEDs 203 are also aligned in height. In this way, when the positions in height of lighting unit 302 and lighting unit 304, and positions of the corresponding LEDs 203 are aligned in height, first door 111 and second door 121 have improved design when they are opened. Furthermore, stored items are efficiently illuminated.

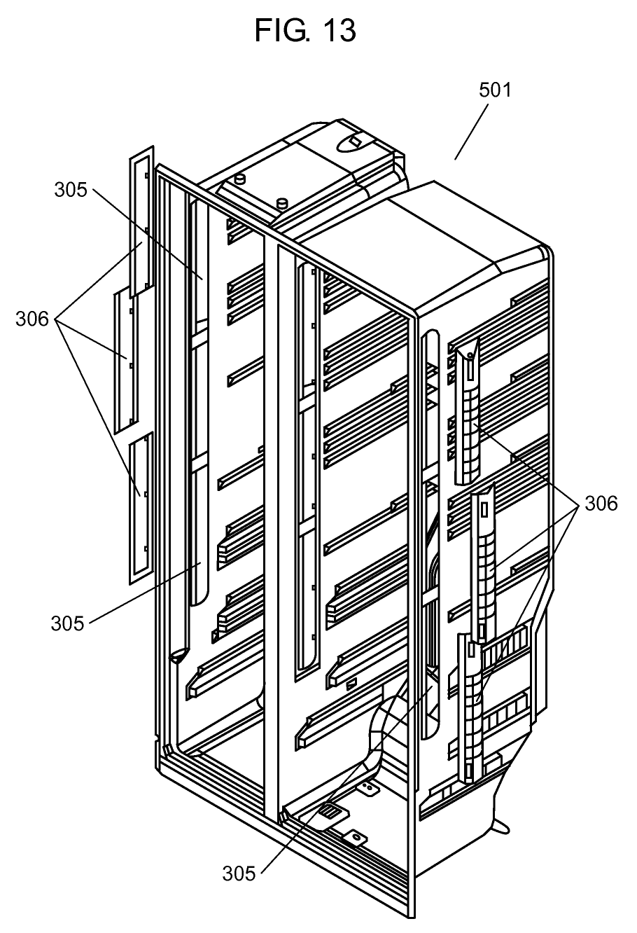

FIG. 13 is a perspective view of an inner box of the refrigerator in this exemplary embodiment. Inner box 501 has a plurality of opening parts 305. Bases 306 are mounted on opening parts 305. Substrate 202 having LED 203 is fixed to base 306. Inner box 501 is coupled to an outer box (not shown) in a state in which base 306 is mounted on opening part 305, and heat-insulating material is filled. Thus, heat-insulating housing 300 is configured.

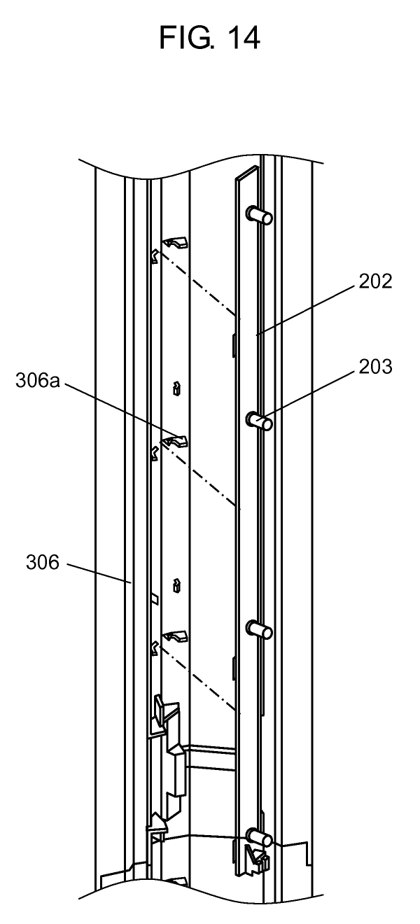

FIG. 14 is a perspective view of the base of the refrigerator in this exemplary embodiment. LED 203 has directivity. Therefore, when substrate 202 is fixed to base 306, LED 203 is required to be fixed in such a manner that it faces the deep side of heat-insulating housing 300. Base 306 includes fixing part 306a for fixing substrate 202. Fixing part 306a is formed in such a manner that LED 203 faces an appropriate direction when substrate 202 is fixed.

Heater 600 is disposed on the opposite side to the rear surface of base 306, that is, substrate 202 of base 306. Specifically, heater 600 as a flat aluminum heater is attached to the rear surface of base 306. Since the length of heater 600 is longer than that of substrate 202, substrate 202 is reliably heated by heater 600. Therefore, similar to the first exemplary embodiment, occurrence of dew condensation is prevented, and substrate 202 or LED 203 is prevented from becoming in a poor electrification state.

The light axis of LED 203 provided in lighting unit 302 in first storage room 151 faces the center of the front of shelf plate 163 of first storage room 151. On the other hand, the light axis of LED 203 may be allowed to face the deep side of partition wall surface 303 at first storage room side, and the light axis of LED 203 provided in lighting unit 304 may be allowed to face a deep side of side wall part 301. In this case, light is reflected in the deep side of heat-insulating housing 300, so that first storage room 151 is illuminated.

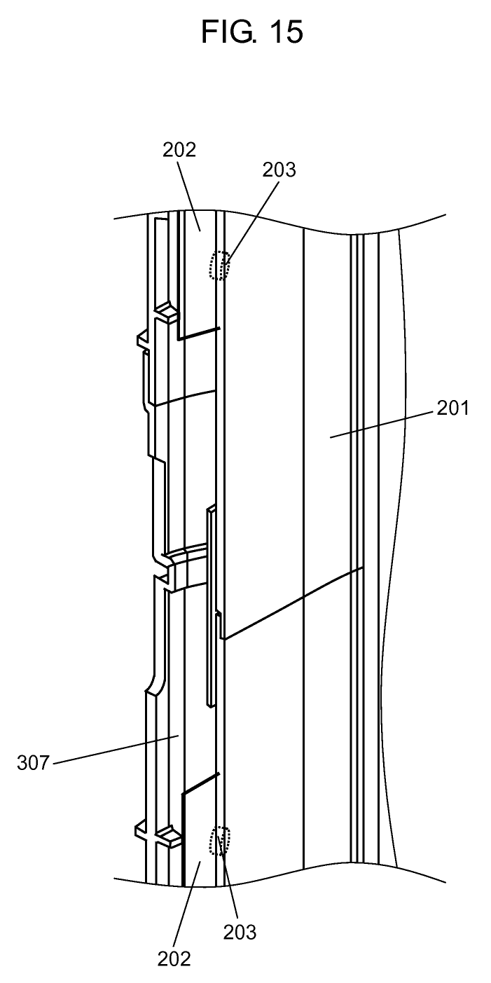

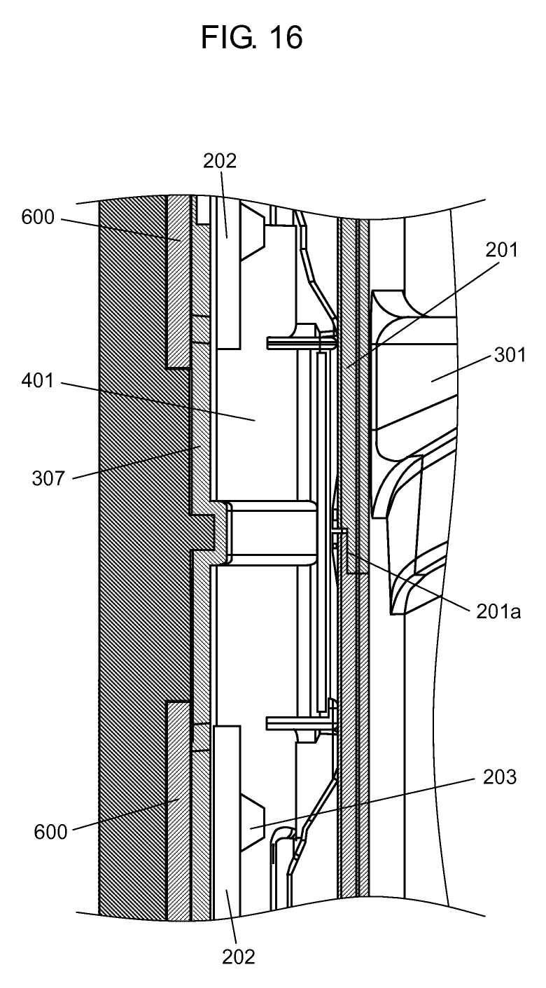

FIG. 15 is another perspective view of the base of the refrigerator in this exemplary embodiment. FIG. 16 is a longitudinal sectional view of FIG. 15. A plurality of opening parts 305 are provided in the vertical direction of heat-insulating housing 300. A plurality of substrates 202 and covers 201 are disposed corresponding to a plurality of opening parts 305, respectively. On the other hand, covers 201 are integrated with each other in such a manner that end portions of the plurality of covers 201 are overlapped with each other. The plurality of covers 201 are integrated with each other by overlapping or connecting thereof. Thus, the inside of cover 201, that is to say, space opposite to first storage room 151 or second storage room 152 is opened continuously in the vertical direction.

On the other hand, a plurality of bases 307 can be disposed corresponding to a plurality of opening parts 305, and the end portions of bases 307 may be overlapped with each other. That is to say, the plurality of bases 307 are integrally configured. Thus, continuous spaces 401 are formed between integrally configured bases 307 and integrally configured covers 201. Space 401 prevents a heat-insulating material from entering when heat-insulating housing 300 is formed. Furthermore, since space 401 is continuous in the vertical direction, when LED 203 is illuminated, the entire part of cover 201 is illuminated. That is to say, a wide range of first storage room 151 or second storage room 152 is illuminated.

When a reflecting plate is provided on base 306 or base 307, light emitted from LEDs 203 is reflected. That is to say, first storage room 151 or second storage room 152 is illuminated brightly. When a part of base 306 or base 307 itself is made of a member that reflects light, a similar advantageous effect can be obtained.

In order to prevent a level difference from occurring on the surface when the end portions of covers 201 are overlapped with each other, covers 201 have level differences 201a in a position to be overlapped. Thus, also when LED 203 is lighted up, the position on which covers 201 are overlapped is not shaded. That is to say, first storage room 151 or second storage room 152 can be illuminated with uniform light.

Since base 307 and cover 201 are made of resin, when they are molded in a long length, the molded product may be deformed. Furthermore, it is difficult to transport a long resin molded product. Base 307 and cover 201 in this exemplary embodiment are formed in the long length by linking a plurality of short length resin molded products. Thus, it is possible to obtain base 307 and cover 201 which are free of deformation and capable of being easily handled.

### Third Exemplary Embodiment

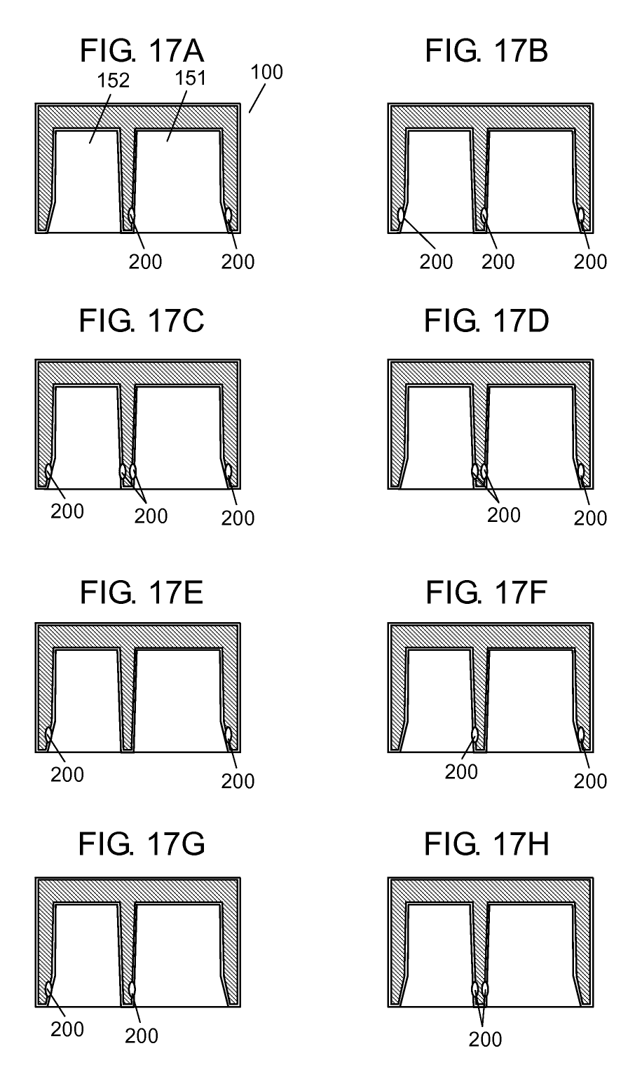

The configuration of lighting units 302 and 304 described in the second exemplary embodiment is applicable to lighting unit 200 in the first exemplary embodiment. Furthermore, based on the first and second exemplary embodiments, examples of arrangement of lighting units 200 for brightly illuminating first storage room 151 and second storage room 152 are described with reference to FIGS. 17A to 17H. Each of FIGS. 17A to 17H is a horizontally taken sectional view of refrigerator 100. Furthermore, the same reference numerals are given to the same configurations as in the first and second exemplary embodiments.

FIG. 17A is a sectional view showing a first example of arrangement of lighting units in a refrigerator in accordance with the third exemplary embodiment of the present invention. Refrigerator 100 includes lighting units 200 on both sides of first storage room 151 as a refrigeration room, and does not include lighting unit 200 in second storage room 152 as a freezing room. Since the freezing room has a temperature range below zero, when a door is opened, dew condensation easily occurs on LED 203 and substrate 202 that are easily exposed to the outside air. Therefore, since lighting unit 200 is not disposed in second storage room 152 as a freezing room, insufficient insulation due to dew condensation is prevented. That is to say, the reliability of refrigerator 100 is improved.

FIG. 17B is a sectional view showing a second example of arrangement of the lighting units in the refrigerator in this exemplary embodiment. Refrigerator 100 includes lighting units 200 on both sides of first storage room 151 as a refrigeration room, and further includes lighting unit 200 on the left side of second storage room 152 as a freezing room, that is to say, on the inner side surface of heat-insulating housing 150. The thickness of a heat-insulating material of heat-insulating housing 150 is larger than that of partition wall 153. That is to say, when lighting unit 200 is disposed on the inner side surface of heat-insulating housing 150, the degree of freedom of the irradiation angle of LED 203 is increased. On the other hand, since second storage room 152 has a narrower width than that of first storage room 151, even if second storage room 152 is lighted from one side, it can be illuminated brightly by adjusting the irradiation angle of LED 203.

FIG. 17C is a sectional view showing a third example of arrangement of the lighting units in the refrigerator in this exemplary embodiment. Refrigerator 100 includes lighting units 200 on both sides of first storage room 151 as a refrigeration room, and on both sides of second storage room 152 as a freezing room. That is to say, both first storage room 151 and second storage room 152 are brightly illuminated. In the vicinity of the opening of second storage room 152, the inner side surface of heat-insulating housing 150 is inclined to some extent with respect to the opening surface. On the other hand, in the vicinity of the opening of second storage room 152, the side surface of partition wall 153 is substantially perpendicular to the opening surface.

Since the irradiation angle of LED 203 disposed on the inner side surface of heat-insulating housing 150 has a greater degree of freedom, the light axis of LED 203 needs to be allowed to face the more rear side of the storage room. On the other hand, the light axis of LED 203, which is embedded in the side surface of partition wall 153, is not allowed to face the rear side too much. Thus, an embedded amount of lighting unit 200 into partition wall 153 is small. Therefore, the thickness of the heat-insulating material of partition wall 153 is not reduced and the heat-insulating performance is maintained.

Note here that LED 203 is embedded in the inner side surface of heat-insulating housing 150. Therefore, even when a device such as an ice-making device is provided in second door 121, cover 201 and the device are not brought into contact with each other when second door 121 is closed. That is to say, it is not necessary to provide a dead space between the device and cover 201.

FIG. 17D is a sectional view showing a fourth example of arrangement of the lighting units in the refrigerator in this exemplary embodiment. Refrigerator 100 includes lighting units 200 on both sides of first storage room 151 as a refrigeration room, and further includes lighting unit 200 on the right side of second storage room 152 as a freezing room, that is to say, on the side surface of partition wall 153. Second storage room 152 can be illuminated brightly from one side of second storage room 152. Furthermore, the length of the electric wiring between a control circuit (not shown) provided on the top panel of refrigerator 100 and substrate 202 can be shortened.

FIG. 17E is a sectional view showing a fifth example of arrangement of the lighting units in the refrigerator in this exemplary embodiment. Refrigerator 100 includes lighting unit 200 on the right side of first storage room 151 as a refrigeration room and on the left side of second storage room 152 as a freezing room. That is to say, lighting unit 200 is disposed on the inner side surface of heat-insulating housing 150. Since lighting unit 200 is not disposed on partition wall 153, it is not necessary to provide opening part 305 on partition wall 153. Consequently, since the heat-insulating performance of partition wall 153 becomes high, the heat-insulating property of first storage room 151 and second storage room 152 is improved. In a refrigerator having doors on right and left sides as in this exemplary embodiment, a width of the refrigeration room and the freezing room is generally small. Therefore, even if the storage room is illuminated from only one side, the inside of the storage room is brightly illuminated sufficiently in practical use.

FIG. 17F is a sectional view showing a sixth example of arrangement of the lighting units in the refrigerator in this exemplary embodiment. Refrigerator 100 includes lighting unit 200 on the right side of first storage room 151 as a refrigeration room, and further includes lighting unit 200 on the right side of second storage room 152 as a freezing room. First storage room 151 and second storage room 152 are illuminated from the same direction. Since LEDs 203 have the same light axis, first storage room 151 and second storage room 152 are illuminated brightly.

FIG. 17G is a sectional view showing a seventh example of arrangement of the lighting units in the refrigerator in this exemplary embodiment. Refrigerator 100 includes lighting unit 200 on the left side of first storage room 151 as a refrigeration room, and further includes lighting unit 200 on the left side of second storage room 152 as a freezing room. The same advantageous effect can be exhibited as in the sixth example of arrangement shown in FIG. 17F.

FIG. 17H is a sectional view showing an eighth example of arrangement of the lighting units in the refrigerator in this exemplary embodiment. Refrigerator 100 includes lighting unit 200 on the left side of first storage room 151 as a refrigeration room, and further includes lighting unit 200 on the right side of second storage room 152 as a freezing room. That is to say, lighting units 200 are disposed on the both side surfaces of partition wall 153. First storage room 151 and second storage room 152 are illuminated from only one side. Thus, power consumption is reduced and at the same time, the length of the electric wiring between LED 203 and the control circuit can be made to be minimized. That is to say, the electric wiring of lighting unit 200 can be gathered.

As mentioned above, partition wall 153 is described with reference to drawings in which it is integrated with an inner box. On the other hand, partition wall 153 can be configured as a different member from the inner box. In this case, lighting unit 200 can be previously disposed in partition wall 153. Thus, assembly work is facilitated, which is advantageous in manufacturing steps. Furthermore, partition wall 153 can be used in common.

### Fourth Exemplary Embodiment

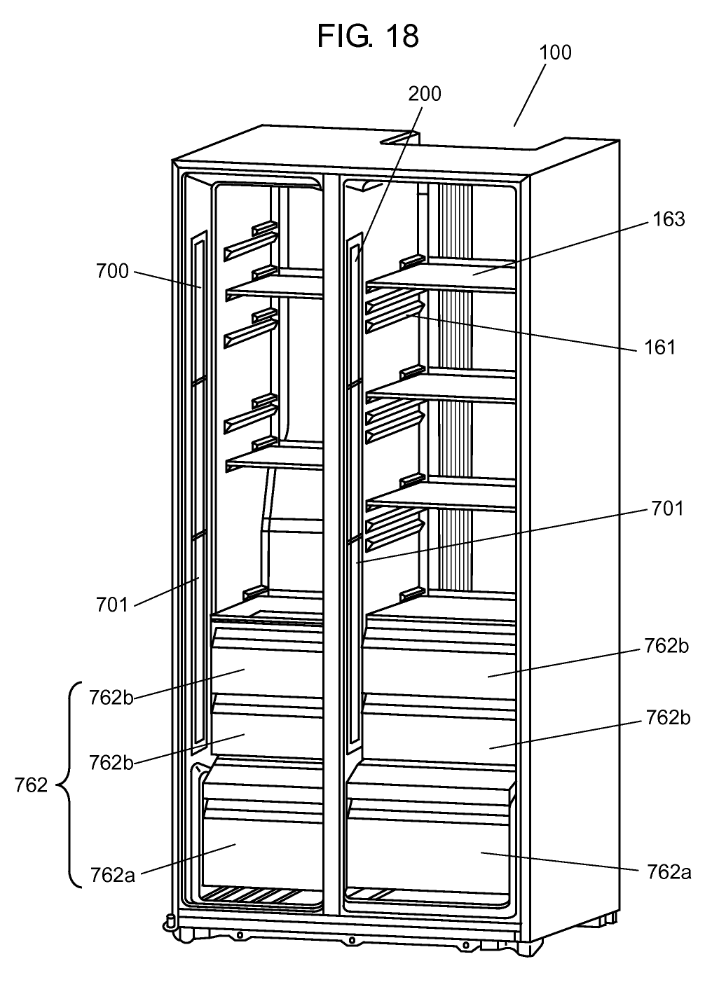

FIG. 18 is a perspective view of a heat-insulating housing of a refrigerator in accordance with a fourth exemplary embodiment of the present invention. That is to say, FIG. 18 is a perspective view of a refrigerator in which a first door and a second door are omitted. This exemplary embodiment is described with the same reference numerals given to the same configuration as in the first and second exemplary embodiments. In this exemplary embodiment, the shapes and dimensions of a drawer and a lighting unit are different from those in the first and second exemplary embodiment.

Among drawers 762 provided in first storage room 151 and second storage room 152, in the lowermost drawers 762a, the front surface is located nearer to the opening of refrigerator 100 as compared with the other drawers 762b. That is to say, the front surfaces of the lowermost drawers 762a are located in the front part, and the front surfaces of the other drawers 762b are located in the deep part.

Lighting unit 700 includes substrate 202 having LED 203 as in the first exemplary embodiment, and provided in the longer length in the vertical direction. The upper end of lighting unit 700 is located in a higher position than the uppermost rail member 161, and the lower end of lighting unit 700 is located in a lower position than the lowermost rail member 161. The lower end of lighting unit 700 is located in a lower position than the lower surface of the uppermost drawer 762, and located in a higher position than the upper surface of the lowermost drawer 762a.

Lighting unit 700 is located in the front part from the front end of shelf plate 163 and the front ends of other drawers 762b. Furthermore, lighting unit 700 is disposed in the back part from the front surfaces of the lowermost drawers 762a. With this configuration, shelf plates 163 and the other drawers 762b are illuminated from the front side by lighting unit 700. Furthermore, even when shelf plate 163 or other drawers 762b contain stored items, cover 701 of lighting unit 700 is not brought into contact with the stored items. That is to say, since lighting unit 700 is not obstructed by stored items, the inside of refrigerator 100 is brightly illuminated.

### INDUSTRIAL APPLICABILITY

As mentioned above, the present invention can provide a lighting unit with which a storage room is brightly illuminated and in which occurrence of dew condensation is suppressed. Therefore, the present invention can be applied for a refrigerator which is divided into a freezing room and a refrigeration room in the right and left direction.

### REFERENCE MARKS IN DRAWINGS

100 refrigerator
111 first door
121 second door
150, 300 heat-insulating housing
151 first storage room (refrigeration room)
152 second storage room (freezing room)
153 partition wall
154 concave portion
161 rail member
162, 762 drawer
163 shelf plate
200, 302, 304, 700 lighting unit
201, 701 cover
202 substrate
203 semiconductor light-emitting element (LED)
306, 307 base
600 heater

1. A refrigerator comprising:
a heat-insulating housing having an opening in a front surface;
a partition wall for dividing the heat-insulating housing into right and left parts; and
a first storage room and a second storage room divided by the partition wall;
wherein a temperature range of the first storage room is set higher than a temperature range of the second storage room,
the partition wall has a lighting unit having a semiconductor light-emitting element as a light source, on at least the first storage room side, and
a heater is disposed on a rear surface of the lighting unit.

2. The refrigerator of claim 1,
wherein the lighting unit includes the semiconductor light-emitting element, a substrate on which the semiconductor light-emitting element is to be mounted, and a base on which the substrate is to be fixed,
and wherein the heather is disposed on the base.

3. The refrigerator of claim 1,
wherein the heater is a flat aluminum heater.

4. The refrigerator of claim 1,
wherein the first storage room is a refrigeration room, and the second storage room is a freezing room.
